(19) United States
(12) Patent Application Publication
(10) Pub. No.: US 2004/0094858 A1
(43) Pub. Date: May 20, 2004

(54) Apparatus for manufacturing foamed thermoplastic resin pellets and method thereof

(76) Inventor: Dong-Hee Kim, Seoul (KR)

Correspondence Address: Cooper & Dunham, 1185 Avenue of the Americas, New York, NY, 10036, US

(21) Appl. No.: 10/472,052

(22) PCT Filed: Aug. 13, 2001
(86) PCT No.: PCT/KR01/01378

(30) Foreign Application Priority Data
Mar. 29, 2001 (KR) 2001-16625
Mar. 29, 2001 (KR) 2001-16626

(51) Int. Cl. B29B 9/00

(52) U.S. Cl. 264/51; 425/4 C; 425/294; 425/295; 425/314; 425/382 R; 264/142

(57) ABSTRACT

The present invention relates to an apparatus for manufacturing foamed thermoplastic resin pellets and method thereof. The manufacturing apparatus includes a cylindrical dice, a plurality of extrusion holes formed along a radial direction of the dice and communicated with a resin flow path formed at the dice, a guide symmetric with the extrusion holes and protrudingly formed at the whole or a portion of outer circumference surface along the longitudinal direction of the dice, an operation member slidably installed along the guide, and a cutting knife with penetration holes being formed along the longitudinal direction of the knife and being communicated with the extrusion holes, wherein both ends of the knife are fixed at the upper edge of the facing planes of the operation member, and its center in the traverse direction is downwardly curved such that it is contacted with the contact line of the extrusion holes. A foaming-rate regulating member is installed at the outer circumference surface of the dice.

### TECHNICAL FIELD

The present invention relates to an apparatus for manufacturing a foamed thermoplastic resin pellet, in which the apparatus comprises a cylindrical dice for extruding thermoplastic resin foams in a radial direction of the dice and a cutting means for continuously cutting the foams extruded from the dice so as to make pellets having uniform size and shape, resulting in continuously foaming a relatively high viscosity thermoplastic resin thereby to make small sized pellets at low cost and in continuous mass production manner and making the extruded foams into pellets of desired uniform size. The present invention also relates to a method for manufacturing a foamed thermoplastic resin pellet using the apparatus.

### BACKGROUND ART

Foamed thermoplastic resin pellets are suitable for forming complicatedly shaped products and have characteristics such as excellent cushioning action, durability to repeated impacts, firm and smooth surface, excellent chemical resistance, moisture resistance, etc. Therefore, they have widely been used in forming various products in a mold, for example, cases for transportation, cushion packing material for impact absorption, cushion material for automobiles, buoy, etc.

Conventional foamed thermoplastic -resin pellets are generally manufactured by melt extruding polystyrenes or hybrid polymers of polystyrenes with other resins to form linear resins, water cooling the linear resins, cutting the cooled resins into pellets to give foamable resin pellets as an intermediate product, and then foaming (including heating/pressurizing) the intermediate product to give final foamed pellets.

Such a manufacturing technique enables pellets to be easily manufactured and thus has conventionally widely been used. However, because a two-step process, i.e. the production of foamable resin pellets as an intermediate product, and subsequent foaming for the production of the final foamed pellets is carried out, total process and equipments are complicated. Furthermore, when used products are incinerated, harmful gas is exhausted. Therefore, use of foamed products manufactured using the above technique has increasingly been restricted.

Recently, therefore, thermoplastic resins which do not exhaust harmful gas, for example, olefin-based resins such as low density polyethylene (LDPE), linear low density polyethylene (L-LDPE), polypropylene (PP), etc. have been used in manufacture of foamed thermoplastic resin pellets.

However, it is difficult to manufacture the above foamed thermoplastic resin pellets using a conventional cutting method, since resins such as LDPE, L-LDPE, etc. have high viscosity. Therefore, a method comprising mixing a thermoplastic resin with a foaming agent, heating/pressurizing and foaming, in a small scale and intermittent manner, has been used.

In detail, first, resin pellets are manufactured considering the foaming ratio and the size of foamed pellets. Then, a large number of resin pellets, water and foaming agent are added to a drum vessel, heated at a temperature below a melting point, pressurized under a high pressure mixed for several minutes (5 to 30 minutes), and open foamed after the foaming agent sufficiently permeates the resin pellet particles to obtain foamed pellets in a small scale and intermittent manner.

However, such a small scale foaming method has problems in that continuous mass production is difficult, manufacturing cost of foamed pellets is increased, and the size of foamed pellets is not uniform.

Generally, foamable polystyrenes can be easily made to pellets. However, high viscosity thermoplastic resins such as low density polyethylene, linear low density polyethylene and polypropylene have problems in that cutting for making pellets is difficult, burs remain in the cut end portions of pellets thereby to degrade quality of pellets, and uniformity of pellets is lowered. Therefore, it is necessary to find economical and practical approaches required for continuously foaming high viscosity thermoplastic resins to make uniform pellets.

The present inventor developed an apparatus for manufacturing a desired foamed thermoplastic resin pellet in a continuous manner in the absence of a separate step for forming a foamable immediate product, in which a thermoplastic resin and a foaming agent are mixed, extruded and foamed to make pellets in a continuous manner. Such an invention has been patented under Korean Patent No. 135899. Since then, a utility model which removed disadvantages of the patent has been registered under Korean Utility Model Registration No. 183571. The present invention improves manufacturing apparatuses of the above invention and utility model thereby to obtain desired foams.

The above patented invention relates to an apparatus for manufacturing a foamed thermoplastic resin pellet, comprising a dice, in which a melt mixture of a thermoplastic resin and a foaming agent is injected into the inlet of the dice and a plurality of extrusion holes are formed at the outlet of the dice in a radial direction of the dice; a pyramid-shaped torpedo, which is installed in a manner such that its one side is fixed at the outlet of the dice and the other side extends toward the inside of the dice; and a cutter, which is installed at the outlet of the dice to be rotated, and cuts linear foams extruded through the extrusion holes formed in a radial direction of the dice to make foamed resin pellets, characterized in that the cutter is equipped with plate-shaped blades being tangentially in contact with the outer surface of the dice which is formed with extrusion holes in a radial direction of the dice.

However, the apparatus has problems as follows: first, because the plate-shaped blades must be installed in a manner such that the cutting edges of the blades are uniformly in contact with the outer surface of the dice in the lengthwise direction of the dice, it is difficult to correctly install the blades so as to smoothly accomplish a desired cutting action. Second, due to such an arrangement of the blades, the sharp edges of the blades are rotated along the surface of the dice in a state wherein they are in contact with the surface of the dice without any gap. Furthermore, upon cutting extrudates by the edges of the blades, cutting process is carried out in a state wherein the edges of the blades are continuously subjected to considerable impacts. Therefore, the edges of the blades are liable to be abraded and damaged and generate severe noise and vibration. Third, contact rotation between the dice and blades generates severe frictional heat. At the same time, air stream produced by rotating blades adversely affects the dice and extrudates extruded from the dice, thereby making a foaming condition unstable. As a result, it is difficult to establish an optimal foaming condition, and shapes of pellets are not uniform due to air stream produced by the rotating blades.

The above registered utility model is characterized in that a cutting means among constituents of the above patented apparatus is a steel wire, and it attempts to solve the problems of the above patent using such wire. In detail, by way of one embodiment, the cutting means is installed at the outer surface of the dice in a manner such that it is extended in a spiral shape along the curved outer surface of the dice formed with extrusion holes and is in close contact with the curved outer surface of the dice. According to another embodiment, the cutting means is installed at the dice formed with extrusion holes in a radial direction of the dice in a manner such that it reciprocally vibrates in the lengthwise direction of the dice or in the opposite direction. The cutting means comprises operating bars formed with a plurality of paired holes, which are alternately communicated with both extrusion holes adjacent to each other by means of vibrational motion, and driving means for operating the operating bars.

The registered utility model was improved in that establishment of cutting steel wires is easy, frictional heat is minimized and little air stream is generated, thereby suppressing the deformation of pellets caused by air stream. However, because foams are cut by impact of steel wires, obtained pellets are not uniform in terms of shape and size. Although use of the operating bars makes it possible to overcome disadvantages of the cutting steel wires and provide excellent effects, it experiences another problem that good closed cells were not formed, thereby lowering the merit as a packing material.

### DISCLOSURE OF THE INVENTION

Therefore, the present invention has been made in view of the above problems, and it is an object of the present invention to provide an apparatus and a method for manufacturing a foamed thermoplastic resin pellet, in which extruded foams can be made into pellets having uniform and desired size, resulting from effectively solving the problems of the above patent and utility model.

In accordance with the present invention, the above object and other objects can be accomplished by the provision an apparatus for manufacturing a foamed thermoplastic resin pellet, comprising a cylindrical dice; a torpedo, which is positioned at the inner center of the dice and is formed with a plurality of resin flow paths spaced apart one from another by a predetermined distance in a radial direction between the outer surface of the torpedo and the inner surface of the dice; a plurality of extrusion holes, which are defined in the cylindrical dice to be spaced apart one from another by a predetermined distance along the resin flow paths and in a radial direction of the dice; and a cutting means, which is installed at the outer surface of the dice portion on which the extrusion holes are formed, and continuously cuts resins extruded from the extrusion holes into foamed resin pellets of uniform size;

characterized in that the cutting means comprises guides, which are protrudingly formed on the whole or a portion of the lengthwise outer surface of the dice in a state wherein a pair of guides are symmetrical with each other about the extrusion hole; operating members which are slidably inserted in the guides; and cutting knives with through-holes being formed in a lengthwise direction of the knife and being communicated with the extrusion holes, wherein both ends of the knife are fixed at the upper edges of the opposing surfaces of a pair of operating members, and the widthwise center of the knife is downwardly curved such that it is tangentially in contact with the extrusion holes.

Preferably, the apparatus for manufacturing a foamed thermoplastic resin pellet may comprise a cylindrical foaming ratio adjusting member, which is installed in a state wherein it seals the outer surface of the dice including the extrusion holes; a product discharge pipe, which is connected to the lower side of the outer surface of the foaming ratio adjusting member and comprises a solenoid valve; a pressure gauge, which is installed on the upper side of the outer surface of the foaming ratio adjusting member so as to control the open-shut state of the solenoid valve; and a cooled air supply pipe, which is connected to a cooled air supply source so as to supply cooled air and apply pressure into the foaming ratio adjusting member.

In accordance with another aspect of the present invention, there is provided a method for manufacturing a foamed thermoplastic resin pellet, comprising the steps of supplying cooled air into a foaming ratio adjusting member for sealing a portion of the outer surface of the dice, so as to maintain pressure and temperature to be constant; supplying resins into the dice and extrusion foaming resins toward the outside of the dice through resin flow paths defined between the dice and the torpedo positioned at the inner center of the dice and through extrusion holes formed in the radial direction of the dice; cutting the extruded foams by means of a cutting knife vibrating at a constant speed; discharging the cut pellets through a product discharge pipe; and maintaining the desired setpoint pressure by re-establishing the inner pressure of the foaming ratio adjusting member or replenishing a consumed pressure upon discharge of the pellets, using a pressure gauge installed at the foaming ratio adjusting member.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cress sectional view showing an apparatus for manufacturing a foamed thermoplastic resin pellet according to the present invention;

FIG. 2 is a general schematic view of the apparatus according to the present invention;

FIG. 3 is a partial perspective view of a dice provided in the apparatus according to the present invention;

FIG. 4 is a cross sectional view along line A-A in FIG. 1;

FIG. 5 is a perspective view showing a cutting means according to one embodiment of the present invention;

FIG. 6 is a cross sectional view showing a cutting means according to another embodiment of the present invention;

FIG. 7 is a perspective view showing the cutting means of FIG. 6;

FIG. 8 is a cross sectional view showing a foaming ratio adjusting member-added apparatus according to the present invention;

FIG. 9 is a cross sectional view along line B-B in FIG. 8; and

FIG. 10 is a partial perspective view showing a foaming ratio adjusting member-added dice according to the present invention.

### BEST MODE FOR CARRYING OUT THE INVENTION

Hereinafter, the present invention will be described in detail with reference to the accompanying figures.

Thermoplastic resin to be used in the present invention comprises normal polystyrene, styrene-acrylonitrile hybrid polymer and styrene-ethylene hybrid polymer, low density- and linear low density- polyethylene, polypropylene, ethylene-propylene hybrid polymer, ethylene-acetate vinyl hybrid polymer, polyvinylchloride, etc. The hybrid polymers can be used alone or in combination.

Foaming agent can be a volatile or a decomposable foaming agent. Examples of the strong volatile foaming agents are aliphatic hydrocarbon such as propane, butane, isobutane, pentane, etc., cycloaliphatic hydrocarbon such as cyclobutane, cyclopentane, cyclohexane, etc., and methylchloride, methylenechloride, dichlorofluoro methane, chlorotrifluoro methane, dichlorodifluoromethane, etc. Examples of the decomposable foaming agents are dinitrosopentamethylenetetra amine, trinitrosotrimethylene amine, benzene sulfonylhydrazide, azodicarbon amide, etc. These foaming agents can be used alone or in combination.

A thermoplastic resin, a foaming agent and other additives are mixed as a thermoplastic resin foam mixture while passing through an extruder.

In detail, the extruder comprises a main extrusion part, a cooling extrusion part and a mixer defined between the main extrusion part and the cooling extrusion part. First, thermoplastic resins are supplied to the main extrusion part and melted and at the same time, the molten resins are transferred to the mixer by means of screw. Then, a foaming agent is injected into, and mixed with the molten resins, followed by agitating. As a result, the foaming agent is uniformly dispersed in and mixed with the thermoplastic resins.

The temperature of the main extrusion part depends on the kind of thermoplastic resins to be injected. For example, for a low density polyethylene, a temperature of 100 to 200° C. is established. The temperature and pressure of the mixer are established at the highest level.

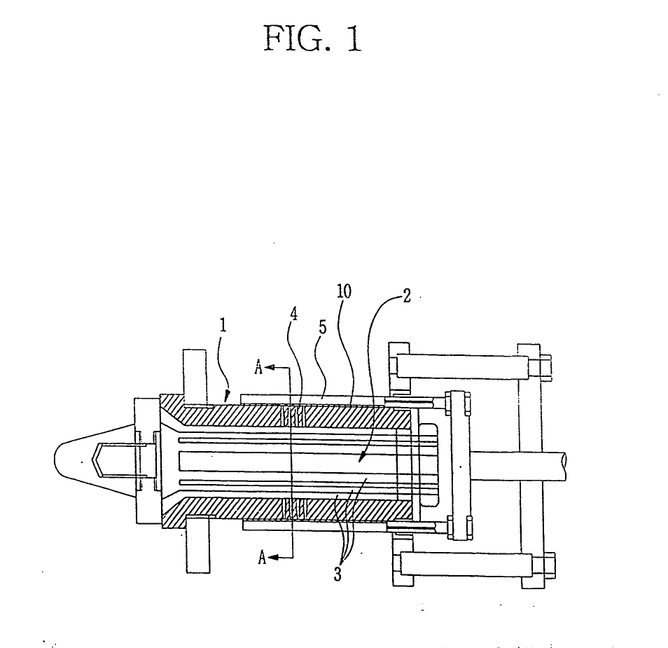

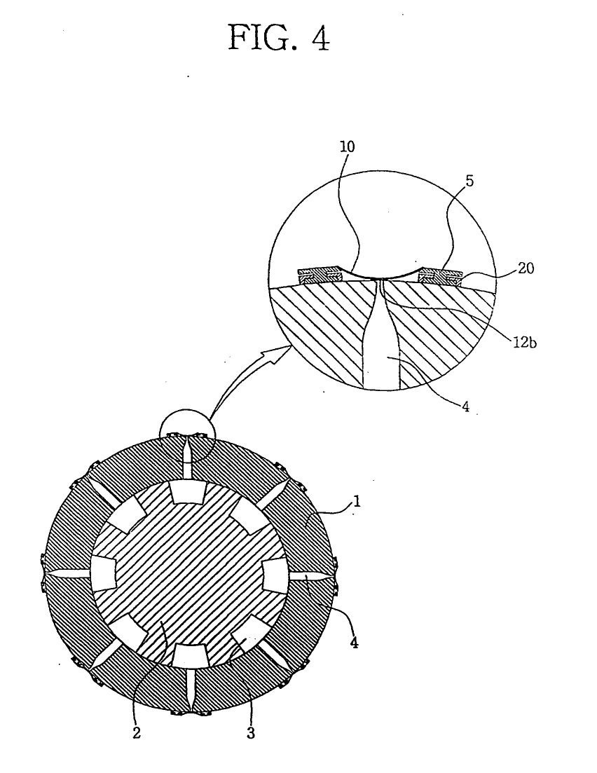

Then, the foam mixture is continuously foamed in the form of pellet by an apparatus shown in FIGS. 1 to 5 according to the present invention.

FIGS. 1 to 5 are an apparatus according to one embodiment of the present invention.

According to one embodiment of the present invention, an apparatus for manufacturing a foamed thermoplastic resin pellet comprises a hollow cylindrical dice (1); a torpedo (2), which is positioned at the inner center of the dice (1) and is formed with a plurality of resin flow paths (3) spaced apart one from another by a predetermined distance in a radial direction between the outer surface of the torpedo and the inner surface of the dice (1); a plurality of extrusion holes (4), which are defined in the cylindrical dice (1) to be spaced apart one from another by a predetermined distance along the resin flow paths (3) and in a radial direction of the dice; and a cutting means, which is installed at the outer surface of the dice portion (1) on which the extrusion holes (4) are formed, and continuously cuts resins extruded from the extrusion holes (4) into foamed resin pellets of uniform size.

The cutting means comprises operation members (5), which reciprocally vibrate in the lengthwise direction of the dice (1) or in the opposite direction, and a driving means enabling the operating members (5) to vibrate.

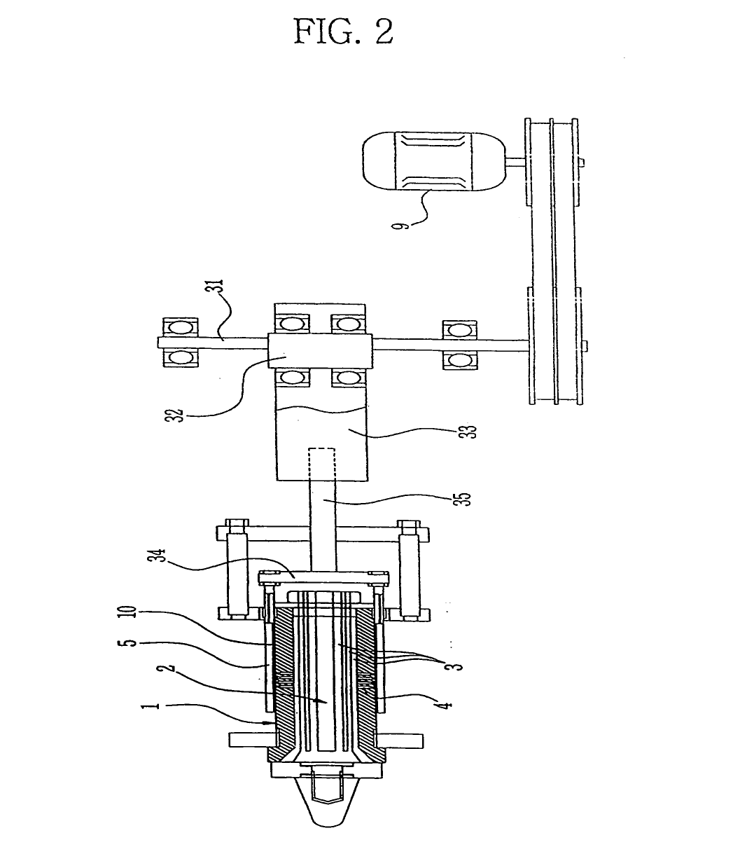

The operating members (5) can vibrate with the aid of various driving means. One example is shown in FIG. 2. A circular eccentric cam (32) is installed at a rotating shaft (31) being rotated by a driving motor (9). The one side end of a crank (33) is connected to the eccentric cam (32) while being supported by a bearing. The crank (33) side ends of the operating members (5) are connected to and fixed at a bearing plate (34). A connecting road (35) is installed between the center portion of the bearing plate (34) and the other side end of the crank (33).

A connecting state of the connecting road (35) in FIG. 2 is shown schematically. However, in detail, eccentric rotational motion of the eccentric cam (32) on the rotating shaft (31) oscillates the crank (33). The oscillating motion of the crank (33) makes the operating members (5) vibrate in a linear and reciprocal manner. For this purpose, the connection between the connecting road (35) and the bearing plate (34) is accomplished using a connecting means such as a universal joint.

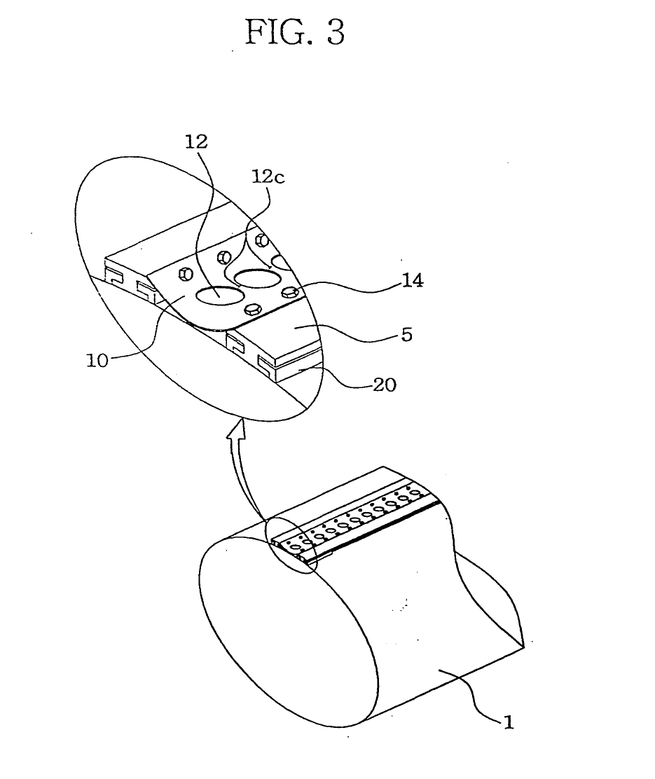

Referring to FIGS. 3 to 5, the cutting means comprises a pair of guides (20), which are symmetrical with each other about a plurality of the extrusion holes (4)) and which are protrudingly formed at the outer surface of the dice (1); a pair of operating members (5), which are slidably inserted in the guides (20); and a cutting knife (10), in which its both lengthwise sides are fixed at the upper edges of the opposing surfaces of a pair of operating members (5) by means of bolts (14).

Guides (20) are preferably installed in pairs at each of the front and rear ends of the dice (1).

The operating members (5) vibrate forward and rearward in the lengthwise direction of the dice (1) by means of the driving motor (9). In order not to be easily separated from the guides (20), the operating members (5) preferably have a 90° rotated “H”-shaped configuration.

More preferably, the upper edges of the one sides of the operating members (5), i.e., the upper edges of the opposing surfaces of a pair of operating members (5) which are symmetrical with each other about the extrusion holes (4) are inclined, thereby easily fixing the cutting knife (10) at the operating members (5) using bolts (14).

The cutting knife (10) is preferably made of heat treated metal so as to have abrasion resistance and corrosion resistance. It comprises a curved portion (12b), in which its widthwise center is downwardly curved like a bow; a plurality of through-holes (12), which are defined in the lengthwise direction of the cutting knife; a bridge portion (12c), which is defined between the through-holes (12); and bolt holes (18).

The curved portion (12b) which is formed at a widthwise center of the cutting knife (10) includes a center line extending in the lengthwise direction of the cutting knife (10).

Preferably, the through-holes (12) are formed in a manner such that their diameter is 20 to 30 times larger than that of the extrusion holes (4), considering the volume expansion of the foams extruded through the extrusion holes (4).

In particular, the cutting knife (10) is preferably installed in a state wherein the curved portion (12b) is tangentially in contact with the extrusion holes (4) of the dice (1).

A portion of an inner edge of each of the through-holes (12) acts as a cutting section (12a). In detail, when the cutting knife (10) is operated, it cuts the lower end of extruded foams to make pellets in a manner such that the foams are torsionally cut while the operating member (5) vibrates forward and rearward within a range of about 2 to 3 mm. As a result, both ends of the pellets are closed and closed cells are maintained.

Where the apparatus according to one embodiment of FIGS. 1 to 5 is operated, a mixture of a foaming agent and a resin is injected into the dice (1) through resin flow paths (3) defined between the dice (1) and the torpedo (2) positioned at the inner center of the dice (1). Then, the mixture is extruded toward the outside of the dice (1) through the extrusion holes (4), which are communicated with the resin flow paths (3) and are formed in the radial direction of the dice (1).

At this time, when one of the through-holes (12) on the cutting knife (10) is communicated with one of the extrusion holes (4) on the dice (1), the two extrusion holes (14) adjacent to the one extrusion hole are blocked by the bridge portion (12c) of the cutting knife (10). As a result., the extrusion of resins through the two extrusion holes is suspended.

In this regard, the extrusion holes (4) are defined along the lengthwise direction of the cutting knife (10) so as to ensure that two adjacent extrusion holes (4) are operationally associated with each through-hole (12) and its adjoining bridge portion (12c), respectively.

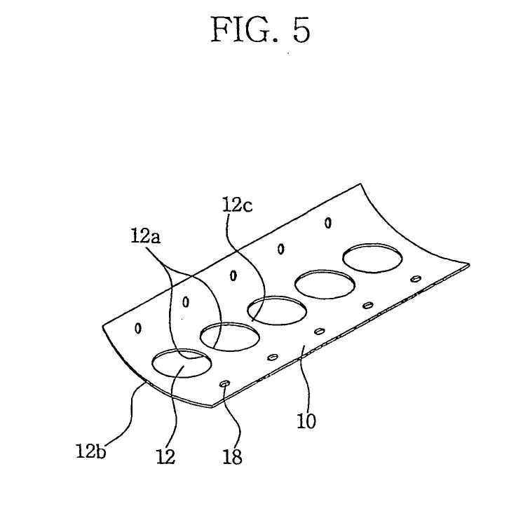

In detail, referring to FIG. 5, a plurality of extrusion holes (4) are defined in a manner such that one extrusion hole (4) is placed at one through-hole (12) and another extrusion hole (4) adjacent to the one extrusion hole is placed at a bridge portion (12c) connecting with the through-hole. Therefore, a plurality of the extrusion holes (4) are spaced apart by a desired distance.

When the driving motor (9) is operated, the rotating shaft (31) is rotated by way of rotatory power of the driving motor (9). The eccentric cam (32) installed at the rotating shaft (31) is eccentrically rotated around the center axis of the rotating shaft (31). Then, the crank (33) connected to the eccentric cam is oscillated and the oscillating motion of the crank (33) is transmitted to the bearing plate (34) through the connecting road (35). As a result, the operating members (5), one end of each of which is connected to and fixed at the bearing plate (34), reciprocally vibrate leftward and rightward (when viewed as in FIG. 5) at the outer surface of the dice (1).

The through-hole (12) and its adjoining bridge portion (12c) of the cutting knife (20) are operationally associated with two adjacent extrusion holes (4) depending on the vibrational motion of the operating members (5). At this time, linear resins are extrusion foamed toward the outside of the dice (1) through the through-holes (12) which are communicated with the extrusion holes (4) at the outer surface of the dice (1). The extruded linear foams are in contact with the cutting section (12a) of the cutting knife (10) geared with the vibrational motion of the operating member (5) and are cut into the pellets having a size depending on the vibration rate of the operating member (5). Then, the pellets are discharged toward the outside of the dice (1).

A large number of extrusion holes (4) are formed in the radial direction of the dice (1) along the resin flow paths (3). Therefore, a large amount of the foamed thermoplastic resin pellets are discharged toward the outside of the dice (1) whenever the operating members (5) vibrate once.

Meanwhile, the cutting section (12a) pressurizes and torsionally cuts the lower side of extrudates while reciprocally vibrating leftward and rightward. Therefore, both ends of pellets containing pores produced upon foaming are closed thereby to make closed cells.

In this case, because extrudates are cut and cooled in a state in which they are raised to their melting point: simultaneously with the cutting of the extrudates by means of the cutting section (12a), both ends of the pellets are closed.

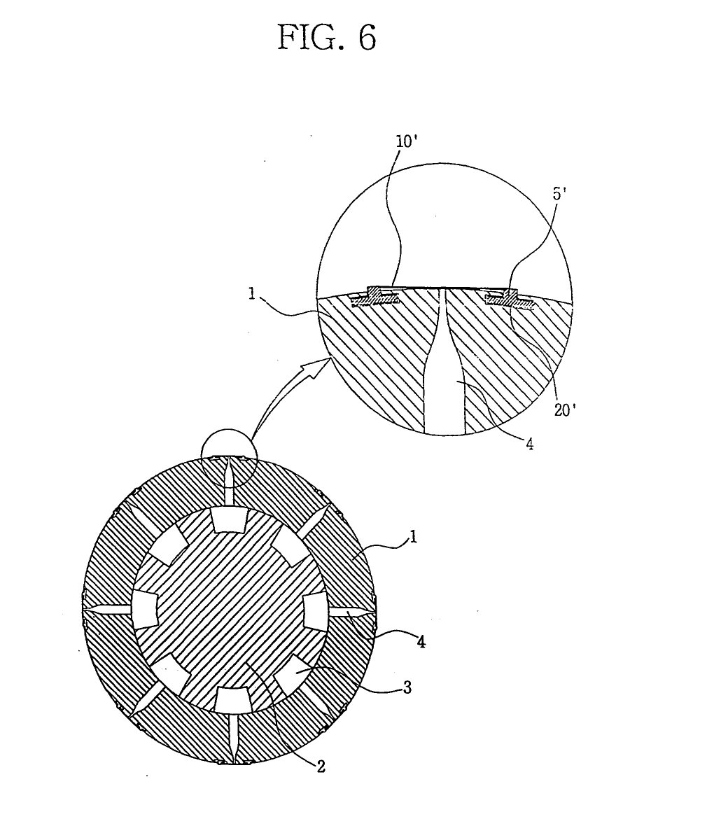

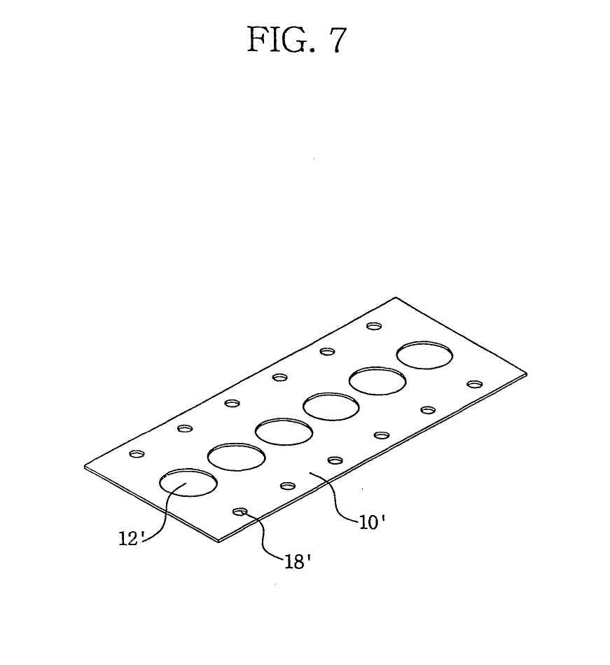

FIGS. 6 and 7 show the cutting means according to another embodiment of the present invention.

Guides (20′) are pitted in a dice (1) in a state wherein a pair of guides are symmetrical with each other about extrusion holes (4) and are extended in the lengthwise direction of the dice (1).

Operating members (5′) in an inverted “T”-shaped configuration are slidably inserted in the guides (20′). The one end of the operating member (5′) is operationally associated with the driving motor (9) mentioned above.

Both lengthwise sides of a cutting knife (10′) are fixed at the opposing surfaces of a pair of operating members (5′) by means of bolts (while being centered on the extrusion hole (4)).

Therefore, the cutting knife (10′) can be easily manufactured in a manner such that through-holes (12′) and bolt holes (18′) are formed on the rectangular plate without being curved, as shown in FIGS. 3 to 5.

The cutting knife (10′) is installed in a state wherein its widthwise center is tangentially in contact with the center of the extrusion holes (4), as described the above.

This is because the contact surface of the dice (1) and the cutting knife (10′) is minimized, thereby to minimize frictional heat.

The cutting means of FIGS. 6 and 7 is operated in the same manner as that of FIGS. 3 to 5.

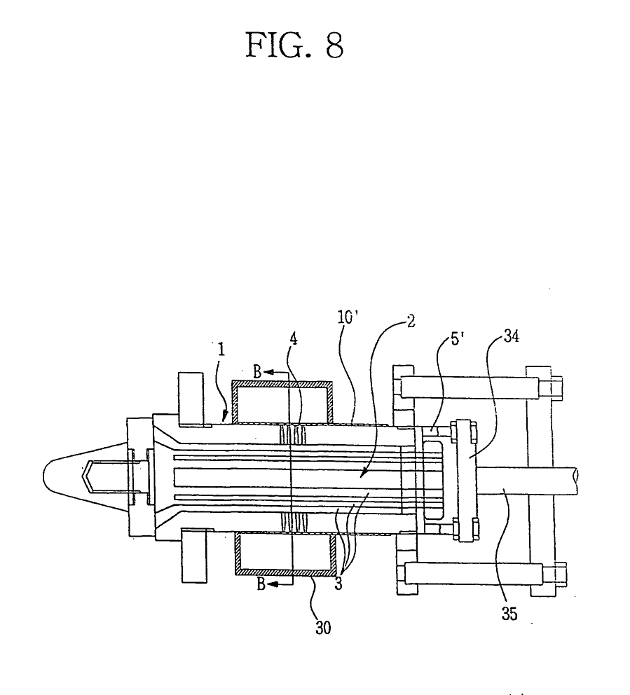

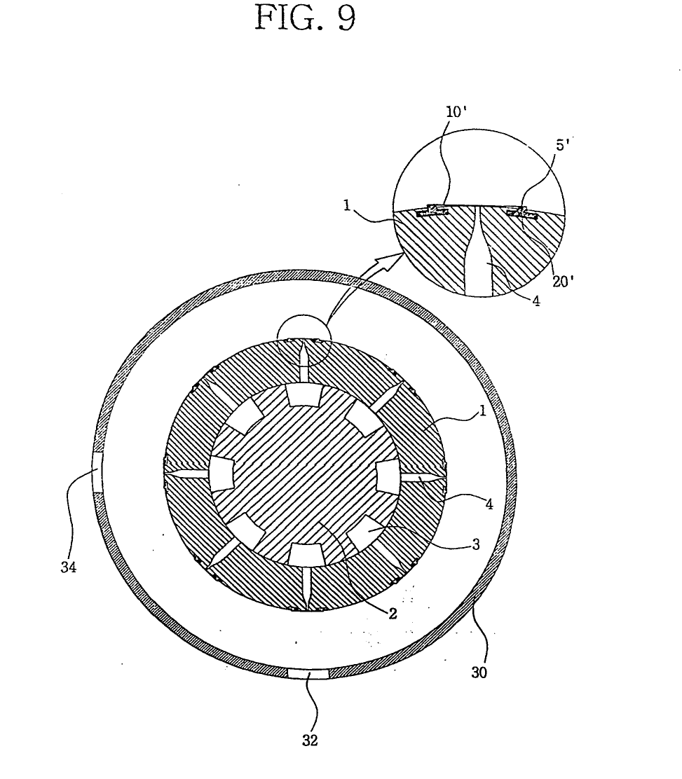

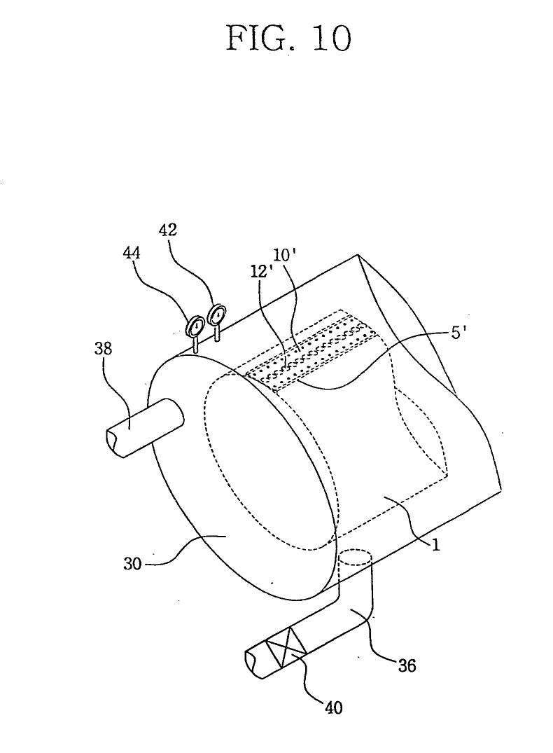

FIGS. 8 to 10 show the structure of a foaming ratio adjusting member (30), which is added to the apparatus of the present invention.

The foaming ratio adjusting member (30) is in a cylindrical tube shape. It is installed at the outer surface of the dice (1) in a manner such that it seals a portion of the cutting knife (10′) and the extrusion holes (4).

That is, the foaming ratio adjusting member seals all the extrusion holes (4) formed at the dice (1) and the outer surface of the dice (1) including the extrusion holes (4), thereby to form a space.

The lower side of the foaming ratio adjusting member (30) is formed with an outlet (32), which penetrates the portion of the edge of the foaming ratio adjusting member. Apart from the outlet (32), another portion of the edge of the foaming ratio adjusting member (30) is formed with a cooled air supply inlet (34).

The outlet (32) is connected to a product discharge pipe (36) equipped with a solenoid valve (40). The cooled air supply inlet (34) is closely connected to a cooled air supply pipe (38), which in turn is connected to a cooled air supply source (not shoe) such as an air cooling tank.

The cooled air supply source may be a known tank and is sufficient that it can supply cooled air of about −10° C., for example, constantly.

In this regard, in order to manufacture a desired size of pellets, the solenoid valve (40) installed in the product discharge pipe (36) is closed and cooled air is supplied into the foaming ratio adjusting member (30) through the cooled air supply pipe (38). Therefore, the inner of the foaming ratio adjusting member is adjusted to have a constant temperature and setpoint pressure.

For example, cooled air of about −10° C. is sufficient for rapidly cooling foams having a melting point of about 220° C. The inner pressure of the foaming ratio adjusting member is automatically controlled by means of a pressure gauge (42), for example, at the level of about 1 to 2 Pa.

Subsequently, a mixture of a foaming agent and a resin is injected into the dice (1) through resin flow paths (3) defined between the dice (1) and the torpedo (2) positioned at the inner center of the dice (1). Then, the mixture is extruded toward the outside of the dice (1) through the extrusion holes (4), which are communicated with the resin flow paths (3) and are formed in the radial direction of the dice (1).

At this time, when one of the through-holes (12′) on the cutting knife (10′) is communicated with one of extrusion holes (4) on the dice (1), the two extrusion holes (4) adjacent to the one extrusion hole are blocked and extrudates are extrusion foamed through the opened extrusion hole (4) and through-hole (12′).

While the operating members (5) which have received a driving power, reciprocally vibrate leftward and rightward (when viewed as in FIG. 7) at the outer surface of the dice (1), foams are cut into pellets having a size depending on the vibration rate of the operating member (5). Then, the pellets are discharged toward the outside of the dice (1).

During this procedure, the outside of extrusion foamed pellets is in contact with cooled air which is charged in the inner of the foaming ratio adjusting member (30) whereby instantaneous heat exchange occurs. Sphere-shaped pellets are manufactured by cooling while the interior of the foaming ratio adjusting member is maintained at a constant pressure.

In addition, where the vibration rate of the operating member (5) is held constant and pressure applied to the outside of the pellets is varied within a predetermined range, the shape and size of pellets can easily be controlled depending on the foaming ratio of pellets, i.e.. the foaming expansion ratio of pellets.

In particular, the pressure gauge (42) and solenoid valve (40) are operationally associated with each other and thus the inner pressure of the foaming ratio adjusting member (30) is always maintained constant. Upon the opening of the solenoid valve (40), manufactured pellets are automatically discharged through the product discharge pipe (36). Therefore, the discharge and conveyance of pellets can be self-operated.

It is understood that the pressure gauge (42) is linked with a switch valve (not shown) installed in the cooled air supply pipe (38) and thus is automatically controlled. Accordingly, consumed pressure is replenished and thus the inner pressure of the foaming ratio adjusting member is always maintained to be constant.

Industrial Applicability

As apparent from the above description, the present invention provides an apparatus and a method for a foamed thermoplastic resin pellet, in which closed cells are formed in pellets and thus the reliability of materials is maximized because the foams are cut by means of the minute vibration of a cutting knife, and desired foamed thermoplastic resin pellets can be continuously manufactured on a large scale without separately forming foamable intermediate products.

Furthermore, high viscosity foamable resins that are difficult to foam due to their high viscosity can be continuously foamed into pellets. The cutting means according to the present inventions generates little noise, vibration, frictional heat and air stream, thereby the quality and uniformity of products being improved still more.

Finally, excellent uniform and sphere-shaped pellets can be obtained by applying a constant pressure on the outer surface of the foams. Because pressure and temperature applied on the outer surface of the foams can be easily controlled, the size and shape of pellets can be easily adjusted depending on the foaming ratio of the pellets.

Although the preferred embodiments of the present invention have been disclosed for illustrative purposes those skilled in the art will appreciate that various modifications, additions and substitutions are possible, without departing from the scope and spirit of the invention as disclosed in the accompanying claims.

1. An apparatus for manufacturing a foamed thermoplastic resin pellet comprising:
a cylindrical dice;
a torpedo, which is positioned at the inner center of the dice and is formed with a plurality of resin flow paths spaced apart one from another by a predetermined distance in a radial direction between the outer surface of the torpedo and the inner surface of the dice;
a plurality of extrusion holes, which are defined in the cylindrical dice to be spaced apart one from another by a predetermined distance along the resin flow paths and in a radial direction of the dice; and
a cutting means, which is installed at the outer surface of the dice portion on which the extrusion holes are formed, and continuously cuts resins extruded from the extrusion holes into foamed resin pellets of uniform size;
characterized in that the cutting means comprises
guides, which are protrudingly formed on the whole or a portion of the lengthwise outer surface of the dice in a state wherein a pair of guides are symmetrical with each other about the extrusion hole;
operating members, which are slidably inserted in the guides; and
cutting knives with through-holes being formed in a lengthwise direction of the knife and being communicated with the extrusion holes, wherein both ends of the knife are fixed at the upper edges of the opposing surfaces of a pair of operating members, and the widthwise center of the knife is downwardly curved such that it is tangentially in contact with the extrusion holes.

2. The apparatus as set forth in claim 1, wherein the cutting means comprises:
guides, which are pitted in the dice in a state wherein a pair of guides are symmetrical with each other about the extrusion hole and are extended in the lengthwise direction of the dice;
operating members, which are slidably inserted in the guides; and
cutting knives with through-holes being formed in a lengthwise direction of the knife and being communicated with the extrusion holes, wherein both ends of the knife are fixed at the upper edges of the opposing surfaces of a pair of operating members, and the widthwise center of the knife is downwardly curried such that it is tangentially in contact with the extrusion holes.

3. The apparatus as set forth in claim 1 or claim 2, wherein the through-holes are formed in a manner such that their diameter is 20 to 30 times larger than that of the extrusion holes.

4. The apparatus as set forth in claim 1, further comprising:
a cylindrical foaming ratio adjusting member, which is installed in a state wherein it seals the outer surface of the dice including the extrusion holes;
a product discharge pipe, which is connected to the lower side of the outer surface of the foaming ratio adjusting member and comprises a solenoid valve;
a pressure gauge which is installed on the upper side of the outer surface of the foaming ratio adjusting member so as to control the open-shut state of the solenoid valve; and
a cooled air supply pipe, which is connected to a cooled air supply source so as to supply cooled air and apply pressure into the foaming ratio adjusting member.

5. A method for manufacturing a foamed thermoplastic resin pellet, comprising the steps of:
supplying cooled air into a foaming ratio adjusting member for sealing a portion of the outer surface of a dice, so as to maintain pressure and temperature to be constant;
supplying resins into the dice and extrusion foaming resins toward the outside of the dice through resin flow paths defined between the dice and the torpedo positioned at the inner center of the dice and through extrusion holes formed in the radial direction of the dice;
cutting the extruded foams by means of a cutting knife vibrating at a constant speed;
discharging the cut pellets through a product discharge pipe; and
maintaining the desired setpoint pressure by re-establishing the inner pressure of tic foaming ratio adjusting member or replenishing a consumed pressure upon discharge of the pellets, using a pressure gauge installed at the foaming ratio adjusting member.
